(19) United States
(12) Patent Application Publication
(10) Pub. No.: US 2015/0285178 A1
(43) Pub. Date: Oct. 8, 2015

(54) REACTIVITY CONTROLLED COMPRESSION IGNITION ENGINE AND METHOD OF COMBUSTION PHASING CONTROL

(71) Applicant: Caterpillar Inc., Peoria, IL (US)

(72) Inventor: Bobby John, Peoria, IL (US)

(73) Assignee: Caterpillar Inc., Peoria, IL (US)

(21) Appl. No.: 14/243,181

(22) Filed: Apr. 2, 2014

(51) Int. Cl. F02D 41/30; F02D 41/00

(52) U.S. Cl. CPC F02D 41/3017; F02D 41/0025; F02D 41/3094; F02D 41/0055

(57) ABSTRACT

A reactivity controlled compression ignition engine compression ignites a stratified reactivity charge mixture, of recirculated exhaust gas, air, a low reactivity fuel and a high reactivity fuel. During steady state operating conditions, combustion phasing control includes adjusting an exhaust gas recirculation (EGR) rate relative to a base EGR rate associated with the steady speed and load. When transitioning to a new speed and load during a transient condition, combustion phasing control does not utilize EGR rate control, but does include adjustments to quantities and timings of at least three injection sequences of the high reactivity fuel.

### TECHNICAL FIELD

The present disclosure relates generally to combustion phasing control in a reactivity controlled compression ignition engine, and more particularly to differences in combustion phasing control variables between steady state operating conditions and transient operating conditions.

### BACKGROUND

Reactivity controlled compression ignition (RCCI) engines may burn a mixture of recirculated exhaust gas, air, a low reactivity fuel and a high reactivity fuel. RCCI combustion events are characterized by their low temperature that is potentially able to achieve near zero emissions of both particulates and oxides of nitrogen with high thermal efficiencies. Low temperature combustion is generally characterized by shorter combustion durations and higher pressure rise rates, and hence load capability is of concern. An extended combustion duration in an RCCI engine can be achieved by reactivity stratification resulting from port injection of low reactivity, low cetane number fuel (e.g., gasoline, ethanol or natural gas) during the intake stroke, and direct injection of the high reactivity, high cetane number fuel (e.g. diesel) during the compression stroke. The low temperature combustion event is governed by chemical kinetics of the fuel/oxidizer mixture.

In an RCCI engine, combustion phasing control is fundamental to maintaining healthy pressure rise rates, acceptable ringing intensities and acceptable peak cylinder pressures. During steady state operating conditions corresponding to a fixed speed and load, combustion control strategies can include increasing or decreasing the exhaust gas recirculation rate, adjusting a ratio of the low reactivity fuel to the high reactivity fuel, and adjusting the injection timing of the high reactivity fuel. During transients, when the engine is transitioning from a first speed and load to a second speed and load, control over combustion phasing can become more difficult, as response time lags in the air system, which includes exhaust gas recirculation (EGR), and can effectively remove EGR rate as an available lever to control combustion phasing. U.S. patent application publication 2011/0288751 appears to teach combustion control during transients through adjustment of a ratio of the low reactivity fuel to the high reactivity fuel.

The present disclosure is directed toward one or more of the problems set forth above.

### SUMMARY

In one aspect, a method of operating a reactivity control compression ignition engine includes mixing a low reactivity fuel, air, and recirculated exhaust gas in an engine cylinder. A high reactivity fuel is directly injected into the engine cylinder in at least one injection sequence during a compression stroke to produce a charge mixture with stratified reactivity. The charge mixture is ignited by compressing the charge mixture. The charge mixture is burned over a combustion duration at a combustion phasing. The engine is transitioned from a first speed and load to a second speed and load. Combustion phasing is controlled toward a desired combustion phasing through adjustment of a first set of variables when the engine is operating in a steady state condition associated with either the first speed and load or the second speed and load. Combustion phasing is controlled through adjustment of a second set of variables, which is different from the first set of variables, when the engine is operating in a transient condition during the transition from the first speed and load to the second speed and load. The adjustment of the first set of variables includes adjustment of a current EGR rate relative to a base EGR rate associated with either the first speed and load or the second speed and load. During transients, the at least one injection sequence includes at least three injection sequences. Adjustment of the second set of variables does not include adjustment of the current EGR rate relative to the base EGR rate, but does include adjustment to at least one of a timing and a quantity of one of the at least three injection sequences of the high reactivity fuel.

In another aspect, a reactivity controlled compression ignition engine includes an engine housing that defines at least one engine cylinder, an intake passage, and an exhaust passage. At least one fuel injector is attached to the engine housing, and positioned to respectively supply fuel from a source of low reactivity fuel and a source of high reactivity fuel to the engine cylinder. A piston is positioned to reciprocate in the engine cylinder between a top dead center and a bottom dead center. The exhaust passage is fluidly connected to the intake passage through an EGR control valve. An electronic controller is in control communication with the EGR control valve and the at least one fuel injector. Means, including the electronic controller, is included for determining a combustion phasing of a compression ignited charge mixture, with stratified reactivity, of recirculated exhaust gas, air, low reactivity fuel and high reactivity fuel. The electronic controller includes a combustion phasing control algorithm configured to control the combustion phasing toward a desired combustion phasing through adjustment of a first set of variables when the engine is operating in a steady state condition associated with a steady speed and load, and control the combustion phasing through adjustment of a second set of variables, which is different from the first set of variables, when the engine is operating in a transient condition, transitioning from a first speed and load toward a second speed and load. The adjustment of the first set of variables includes adjustment of a current EGR rate relative to a base EGR rate associated with either the first speed and load or the second speed and load. Adjustment of the second set of variables does not include adjustment of the current EGR rate relative to the base EGR rate, but does include adjustment to at least one of a timing and a quantity of one of at least three injection sequences of the high reactivity fuel.

### BRIEF DESCRIPTION OF THE DRAWINGS

FIG. 1 is a schematic view of a reactivity controlled compression ignition engine according to one aspect of the present disclosure;

FIG. 2 is a graph of steady state injection strategy for the RCCI engine of FIG. 1;

FIG. 3 is another steady state injection strategy for the RCCI engine of FIG. 1;

FIG. 4 is a transient injection strategy for the RCCI engine of FIG. 1 according to an aspect of the present disclosure; and

FIG. 5 is a logic flow diagram of a combustion phasing control algorithm according to another aspect of the present disclosure.

### DETAILED DESCRIPTION

Reactivity controlled compression ignition (RCCI) may result in low temperature combustion with low levels of NOx and soot emissions without the combustion phasing problems associated with homogeneous charge compression ignition. RCCI gains more control over combustion phasing by using two or more fuels of differing reactivities in a compression ignition engine. In most instances, the bulk of the heat release from the combustion event originates from burning a low reactivity fuel such as gasoline, ethanol or natural gas, which all have low cetane numbers. The minority fuel is a high reactivity or high cetane number of fuel, such as distillate diesel fuel, biodiesel, dimethyl ether or other fuels with similarly high cetane numbers known in the art. In RCCI engines, combustion is governed by chemical kinetics of the fuel. In one specific example, an RCCI engine might burn at least 15% distillate diesel fuel, with the remainder being the low reactivity fuel in an engine with a geometric compression ratio on the order of 12:1 to 14:1. Extended combustion durations are achieved by reactivity stratification within the engine cylinder, potentially allowing RCCI engines to operate at load levels beyond those achievable with homogeneous charge compression ignition engines, and may offer load levels approaching those associated with conventional diesel engines, but without the exhaust after treatment systems associated with conventional diesel fuel combustion to achieve comparable emissions.

Combustion phasing control in an RCCI engine is fundamental to maintaining healthy pressure rise rates, acceptable ringing intensities and acceptable peak cylinder pressures. Accordingly, a combustion control strategy may include increasing or decreasing the exhaust gas recirculation (EGR) rate, adjusting a ratio of low reactivity fuel to high reactivity fuel, and adjusting injection timing of the diesel fuel injection event. At steady state speeds and loads, these conventional control strategies are sufficient to maintain adequate control over combustion phasing, but during transients, when the engine is transitioning from a first speed and load to a second speed and load, these conventional strategies will not be sufficient, due at least in part to time lags in the air supply and EGR system response. Therefore, new strategies are desired for transient conditions, to better maintain combustion control and avoid excessively high pressure rise rates, excessive peak cylinder pressures as combustion phasing is advanced, or an actual loss of combustion or misfire if the combustion phasing becomes too retarded. The present disclosure teaches a triple injection sequence strategy of the highly reactive fuel during transient conditions as a robust methodology for retaining combustion phasing control during transient conditions. As used in this disclosure, an injection sequence includes one or more discrete injection events. Nevertheless, in the context of the present disclosure, each of the described injection sequences may typically include exactly one injection event. But the present disclosure recognizes that similar results can be achieved when a single injection event is, for instance, divided into two closely coupled injection events with a same quantity and similar timing as a single injection event.

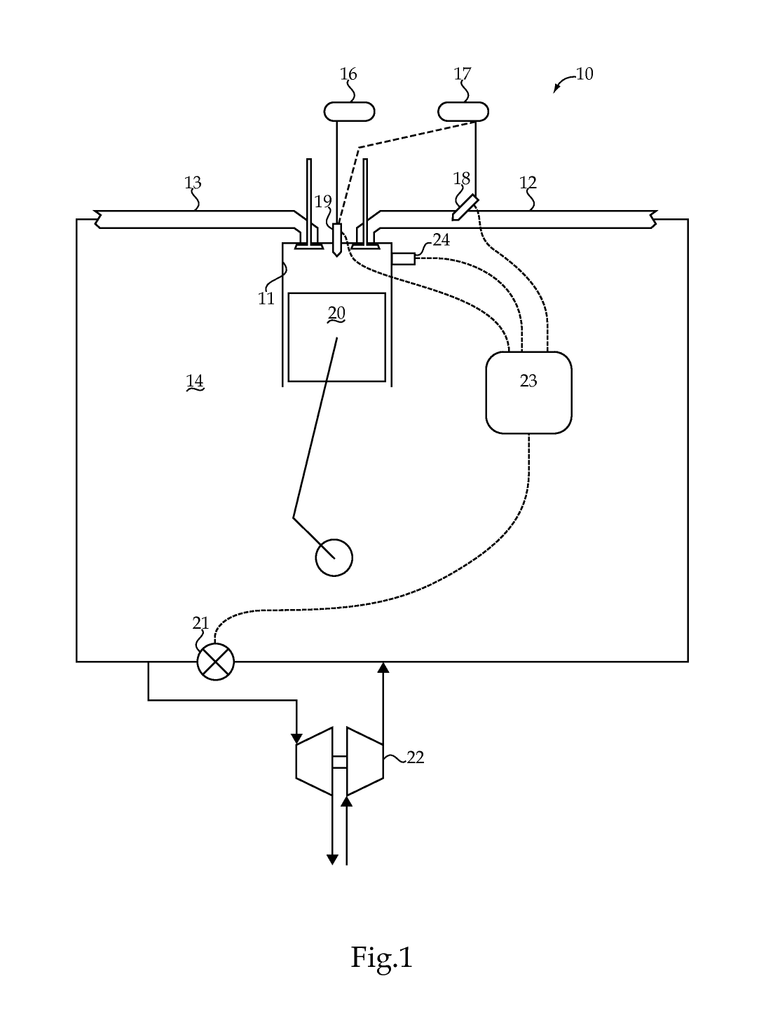

Referring now to FIG. 1, a reactivity controlled compression ignition engine 10 includes an engine housing 14 that defines at least one engine cylinder 11, and intake passage 12 and an exhaust passage 13. A source of low reactivity fuel 17, which could be a natural gas common rail, is fluidly connected to a fuel injector 18 for port injecting the low reactivity fuel into the intake passage 12 in a manner well known in the art. A source of high reactivity fuel 16, which could be a diesel common rail, is fluidly connected to a fuel injector 19 for direct injection of the high reactivity fuel directly into the engine cylinder 11. Although the RCCI engine 10 shows separate port injection of the low reactivity fuel and direct injection of the high reactivity fuel, fuel injector 19 could be a so called dual fuel injector capable of injecting fuel originating from either the source of low reactivity fuel 17 (see dashed line) or high reactivity fuel from the source of high reactivity fuel 16. Such an alternative would still be within the intended scope of the present disclosure. A piston 20 is positioned to reciprocate in the engine cylinder 11 between a top dead center and a bottom dead center. The exhaust passage 13 is fluidly connected to the intake passage 12 through an EGR control valve 21. A turbocharger 22 is shown as part of RCCI engine 10.

An electronic controller 23 is in control communication with the EGR control valve 21, the port fuel injector 18 and the direct fuel injector 19 in a conventional manner. The RCCI engine 10 also includes a means for determining a combustion phasing of a compression ignited charge mixture having stratified reactivity. According to an aspect of this disclosure, the charge mixture will include recirculated exhaust gas, air, low reactivity fuel and high reactivity fuel. This means will necessarily include a combustion phasing determination algorithm executed by the electronic controller 23, and may include one or more sensors that provide information for real time determination of combustion phasing by the electronic controller 23. For instance, the RCCI engine 10 is shown as including a cylinder pressure sensor 24 that communicates cylinder pressure information to electronic controller 23. Those skilled in the art will recognize that, once the cylinder pressure is known, the electronic controller can calculate the heat release rate profile with a combustion phasing determination algorithm and deduce the combustion phasing among other parameters in a manner known in the art. Any strategy that utilizes the electronic controller 23 to determine combustion phasing is intended to fall within the scope of the present disclosure.

The electronic controller 23 also includes a combustion phasing control algorithm configured to control the combustion phasing toward a desired combustion phasing through adjustment of a first set of variables when the engine is operating in a steady state condition associated with a steady speed and load. The first set of variables includes adjustment of a current EGR rate relative to a base EGR rate associated with the steady speed and load. For instance, those skilled in the art will appreciate that electronic controller 23 may be equipped with a look up table with a base EGR rate for each combination of steady speed and load. Alternatively, a base EGR rate for a steady speed and load could also be determined in real time by other means such as one or more equations, a physics-based model, or the like, without departing from the present disclosure. Those skilled in the art will appreciate that in general, increasing the EGR rate will retard combustion phasing, whereas decreasing the EGR rate will advance combustion phasing. The first set of variables might also include adjustment to a ratio of low reactivity fuel to high reactivity fuel. Assuming that the engine operates with a single injection sequence during steady speed and load, the first set of variables could also include adjustment to the timing of the injection event. In the event that the steady speed and load operation utilizes two injection sequences of the high reactivity fuel, the first set of variables could include adjustment to the timing of one or both of the injection sequences and also include adjustment to quantity distributions of the high reactivity fuel among the two injection sequences. Thus, the present disclosure contemplates steady speed and load operation that includes one, two, or more injection sequences of high reactivity fuel.

The combustion phasing control algorithm of the electronic controller 23 controls the combustion phasing through adjustment of a second set of variables, which is different from the first set of variables, when the engine is operating in a transient condition, transitioning from a first speed and load toward a second speed and load. Because transitioning to a new speed and load includes transitioning from a first base EGR rate associated with the first speed and load to a second base EGR rate associated with the second speed and load, the second set of variables does not include adjustment of the current EGR rate relative to either the first base EGR rate or the second base EGR rate. As discussed above, the time required to effect changes in the current EGR rate relative to either a first base EGR rate or a second base EGR rate during a transient may be greater than the duration of the transient event itself Thus, one of the control levers available for controlling combustion phasing during steady speed and load, namely EGR flow rate, may not be effective during transient conditions. The present disclosure addresses this problem by utilizing at least three injection sequences of the high reactivity fuel during transient conditions. According to an aspect of the disclosure, the second set of variables includes adjustment of at least one of a timing and a quantity of one injection sequence of the at least three injections sequences of the high reactivity fuel.

The at least three injection sequences performed during transient conditions include a first injection sequence in a first timing window from 100° to 60° before top dead center (BTDC). Especially favorable results have been observed when the first injection sequence is performed between 80° to 70° BTDC. A second injection sequence is performed in a second timing window from 60° to 30° (BTDC). Better results have been observed when the second injection sequence is performed between 50° to 40° BTDC. The third injection sequence is performed in a timing window from 30° BTDC to 10° after top dead center (ATDC). Better results have been observed when the third injection sequence is performed between 30° and 20° BTDC.

Preferably, but not necessarily, all of the high reactivity fuel is injected before autoignition conditions for the high reactivity fuel have arisen in the cylinder in order to avoid diffusion type or non-premixed burning characteristics associated with conventional diesel engine operation that may produce elevated levels of NOx and soot. As stated earlier, the complete RCCI combustion event is preferably controlled by chemical kinetics more typical of premixed flames rather than diffusion flame propagation as in conventional diesel engines. The third injection sequence occurring after autoignition conditions have arisen is also within the intended scope of this disclosure.

Advancing the timing of the first injection sequence, with other injection timings of the at least three injection sequence fixed, retards the combustion phasing, while retarding the timing of the first injection sequence advances combustion phasing. Advancing the timing of the second injection sequence, with other injection timings fixed, retards the combustion phasing, while retarding the timing of the second injection sequence advances the combustion phasing. Advancing the timing of the third injection sequence, with other injection sequence timings fixed, advances the combustion phasing, while retarding the timing of the third injection sequence retards combustion phasing.

With regard to fuel distribution, redistributing the high reactivity fuel quantity to increase the fuel quantity in the first injection sequence retards the combustion phasing. Increasing the fuel quantity of the second injection sequence advances the combustion phasing. Increasing the fuel quantity of the third injection sequence also advances the combustion phasing. In most instances, the present disclosure would recommend distributing the high reactivity fuel among the three injection sequences such that a majority of the fuel quantity is injected in the first injection sequence, and the least amount is injected in the third injection sequence. Nevertheless, those skilled in the art can deviate from this teaching without departing from the intended scope of the present disclosure. Thus, a combustion phasing control algorithm according to the present disclosure might be configured to change timings of at least one injection sequence of the at least three injection sequences to advance a retard combustion phasing. Likewise, the combustion phasing control algorithm might be configured to change a quantity distribution among the at least three injection sequences to advance a retard combustion phasing. The present disclosure contemplates at least one adjustment for each engine cycle in an effort to control combustion phasing, but does not rule out multiple adjustments to different variables of the second set of variables in order to control combustion phasing during transient conditions.

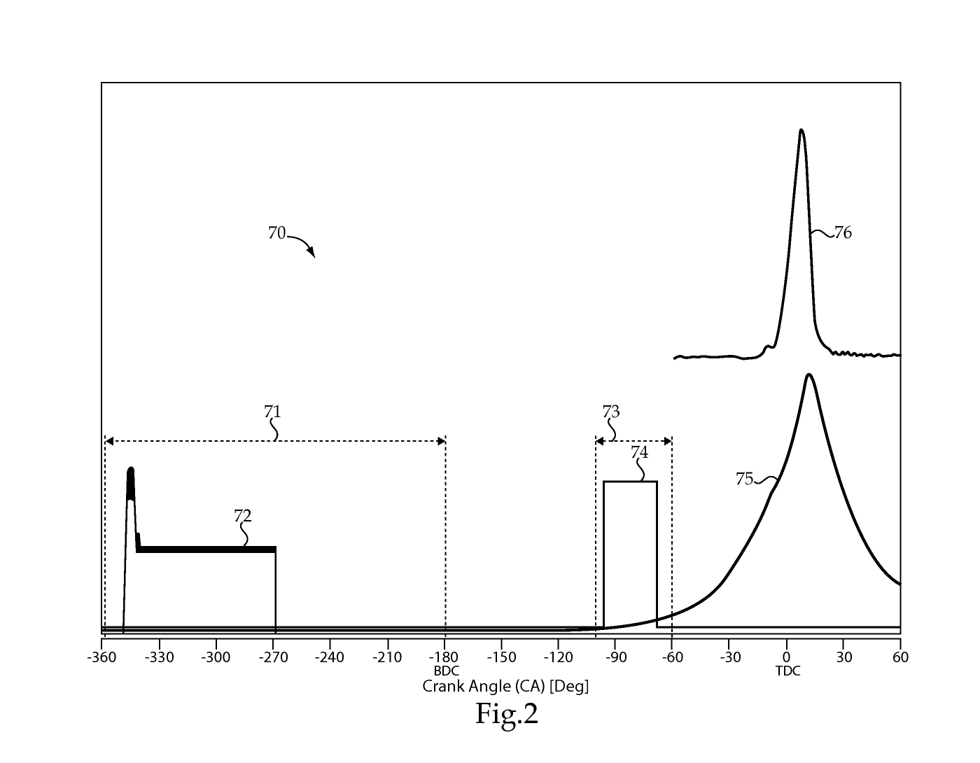

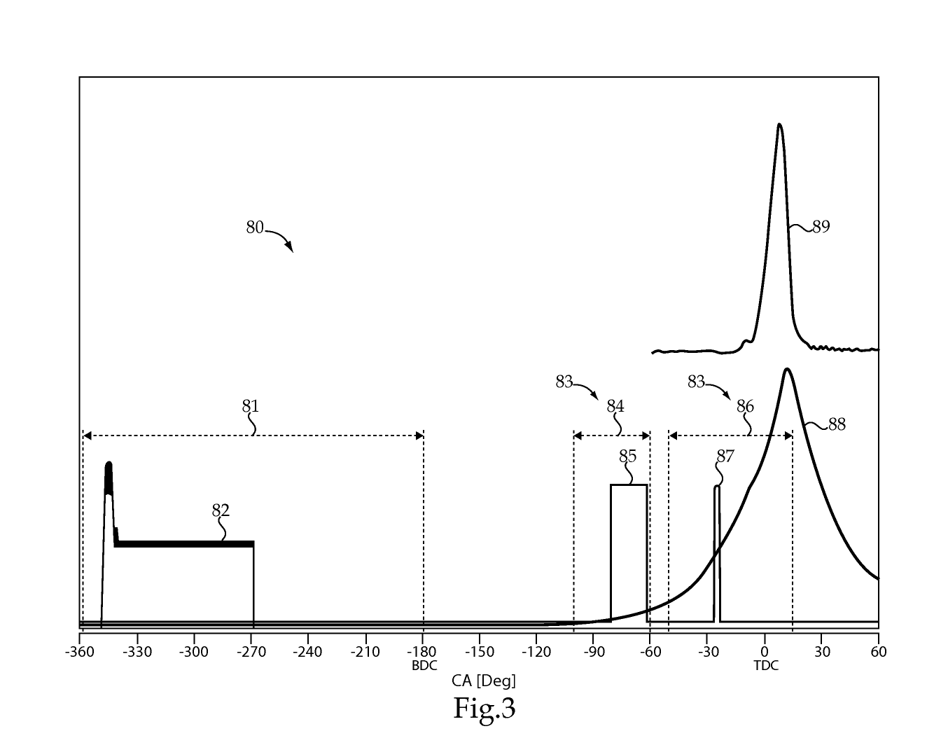

Referring in addition to FIGS. 2 and 3, two example steady state injection strategies for the RCCI engine of FIG. 1 are illustrated. The injection strategy 70 of FIG. 2 shows all of the high reactivity fuel injected in a single injection event, which corresponds to a single injection sequence, whereas the injection strategy 80 of FIG. 3 shows the high reactivity fuel being injected in two separate injection events, which corresponds to two injection sequences in two separate timing windows.

Referring specifically to the steady state injection strategy 70 of FIG. 2, the low reactivity fuel injection 72 is generally timed to occur anywhere during the low reactivity timing window 71 that is shown as extending the complete duration of the intake stroke. This early injection timing can allow for homogenous mixing of the low reactivity fuel, recirculated exhaust gas and air. Injecting the low reactivity fuel at other timings, including during the compression stroke in the case of direct in-cylinder injection, could also fall within the intended scope of the present disclosure. The high reactivity injection sequence 74, which comprises a single injection event, is performed in a high reactivity timing window 73 that extends from 100° to 60° BTDC. Further to the right in the image, a trace of cylinder pressure 75, and above that the corresponding heat release rate 76 demonstrates a combustion phasing in a vicinity of several degrees after top dead center (ATDC) according to the crank angle for 50% heat release (CA50) definition. Nevertheless, any definition of combustion phasing could be used without departing from the scope of the present disclosure. Thus, the present disclosure might teach increasing the current EGR rate if a later combustion phasing were desired, say 10° after top dead center (ATDC) for example.

Referring now to FIG. 3, an alternative steady state injection strategy 80 differs from the steady state injection strategy 70 of FIG. 2 by dividing the high reactivity fuel among two injection sequences that occur in two timing windows, respectively. In the steady state injection strategy 80, the low reactivity fuel 82 is injected anywhere in the low reactivity timing window 81, which may extend the complete duration of the intake stroke. The high reactivity fuel is injected in two injection sequences 83 with a first injection sequence 85, which comprising a single injection event, occurs in a first timing window 84 that extends from 100° to 60° BTDC. A second injection sequence 87, which again comprises a single injection event, is performed in a second timing window 86 that extends from 50° BTDC to 15° ATDC, with better combustion results observed in the range from 45° to 0° BTDC. As shown by the relative durations of the first injection sequence 85 and the second injection sequence 87, a majority of the high reactivity fuel is injected in the first injection sequence according to this aspect of the disclosure.

Curve 88 shows cylinder pressure within engine cylinder 11, and curve 89 shows the corresponding heat release when the charge mixture of recirculated exhaust gas, air, low reactivity fuel, and high reactivity fuel are compression ignited and burned at a combustion phasing about several degrees ATDC. The combustion phasing can be controlled toward a desired combustion phasing, if different from that shown, by adjusting the current EGR rate relative to a base EGR rate associated with the current steady speed and load, or possibly adjusting at least one of a timing and a quantity of high reactivity fuel in one or both of the first injection sequence 85 and second injection sequence 87. For instance, advancing the timing of the second injection sequence 87 would tend to advance combustion phasing, and vice versa.

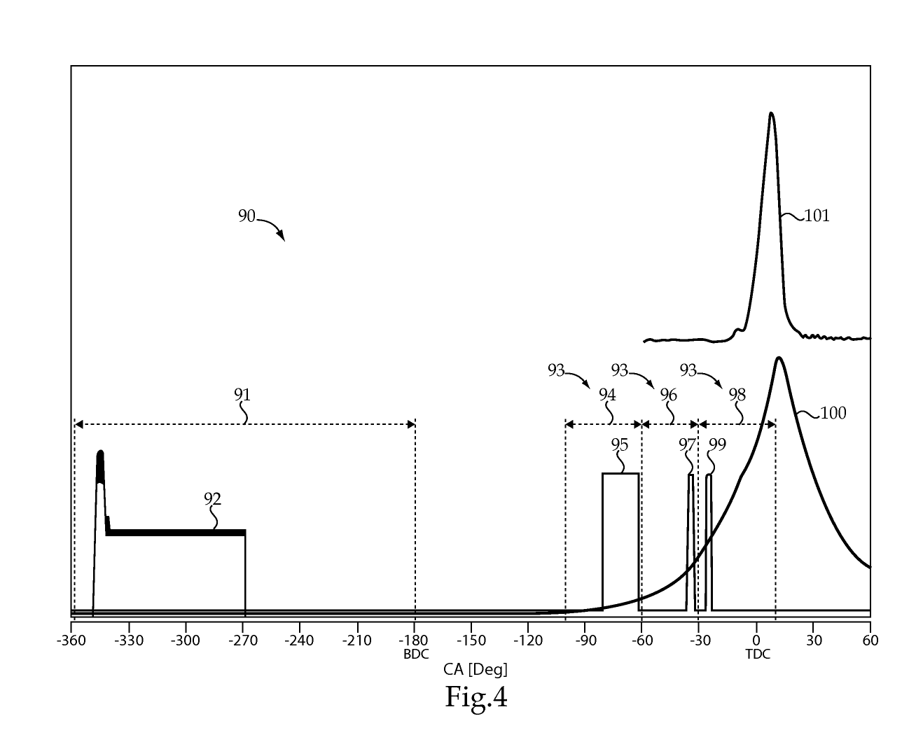

Referring now to FIG. 4, a transient injection strategy 90 according to the present disclosure differs from the steady state injection strategies 70, 80 of FIGS. 2 and 3 by the inclusion of three injection sequences in three discrete timing windows, as opposed to one or two injection sequences as in the steady state injection strategies 70, 80 of FIGS. 2 and 3. Transient injection strategy 90, like the other injection strategies, includes a low reactivity fuel injection 92 that occurs in a low reactivity timing window 91 that spans the duration of the intake stroke. The high reactivity fuel is injected in three injection sequences 93, which includes a first injection sequence 95 in a first timing window 94, a second injection sequence 97 in a second timing window 96, and a third injection sequence 99 in a third timing window 98. In this exemplary embodiment, each of the injection sequences 95, 97 and 99 constitute a single injection event, but each injection sequence could constitute two or more injection events without departing from the intended scope of the present disclosure.

Also shown in FIG. 4 is the cylinder pressure trace 100 and the heat release rate trace 101 showing combustion phasing about several degrees ATDC, again according to the CA50 definition. As discussed earlier, during the transient condition, combustion phasing is not controlled by adjusting a current EGR rate relative to a base EGR rate, but instead is controlled by adjusting timings and quantity distribution of the high reactivity fuel among the three injection sequences 93. For instance, the combustion phasing could be advanced by increasing the quantity of fuel in the second injection sequence 97, or by retarding a timing of the second injection sequence 97, or both. On the other hand, the combustion phasing may be retarded by advancing the timing of the first injection sequence 95 and/or increasing the fuel quantity in the first injection sequence 95 through redistribution of the total amount of high reactivity fuel of the three injection sequences 93. Those skilled in the art will appreciate that the at least three injection sequences taught by the present disclosure for use during transient conditions can also be employed during steady state operating conditions without departing from the present disclosure.

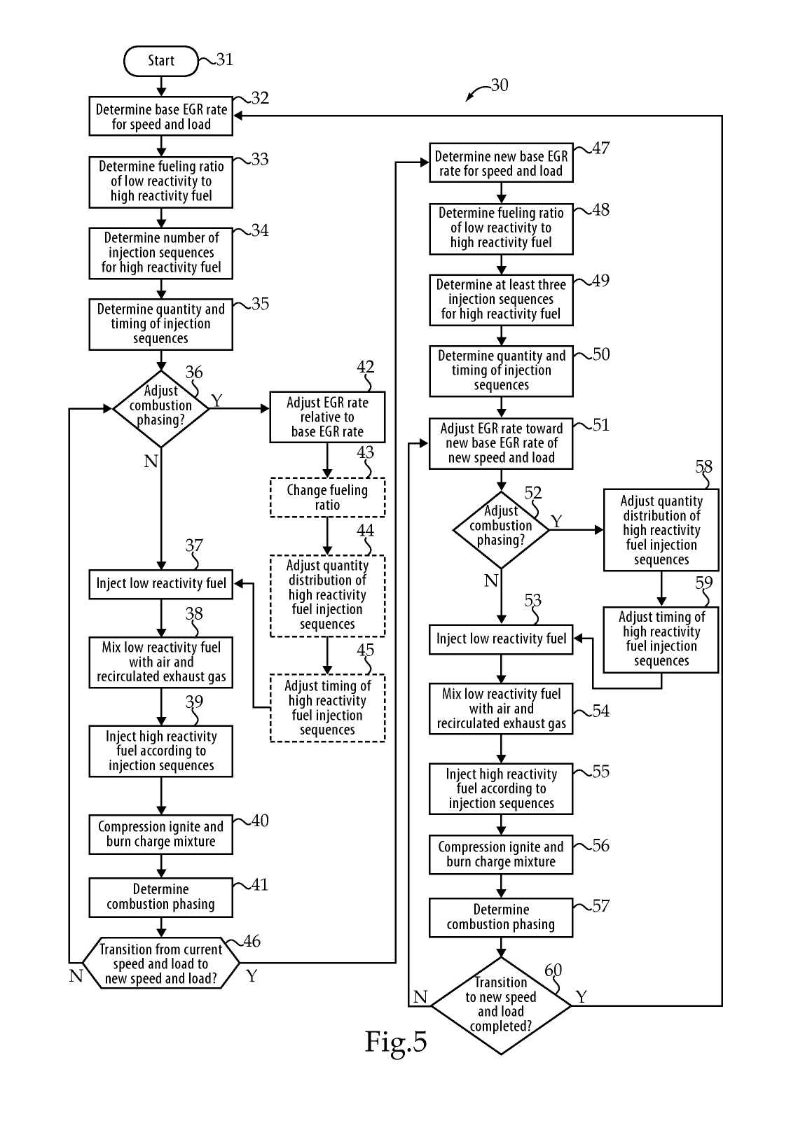

Referring now in addition to FIG. 5, the logic flow for one example combustion phasing control algorithm 30 is illustrated. The logic begins at oval 31 and proceeds to box 32 to determine a base EGR rate for the current steady speed and load. In box 33, a fueling ratio of low reactivity fuel to high reactivity fuel for that steady speed and load is determined. Next, at box 34, the logic determines a number of injection sequences for the high reactivity fuel. As stated earlier, box 34 may return one, two, three or more injection sequences for injection of the high reactivity fuel. Next, at box 35, the logic determines a quantity and timing of each injection sequence of the high reactivity fuel. At query 36, the logic asks whether combustion phasing is in need of being adjusted. In general, this is accomplished by comparing a combustion phasing of a previous combustion event to a desired combustion phasing. If the query returns a negative, the logic advances to box 37 where the low reactivity fuel is injected, such as per the illustrations of FIGS. 2-4. In box 38, the low reactivity fuel is mixed with air and recirculated exhaust gas, possibly to the point of generally constituting a homogenous mixture. At box 39, the high reactivity fuel is injected according to the number, quantity, and timing determined in boxes 34 and 35. At box 40, the charge mixture is ignited and burned. At box 41, the combustion phasing is determined, such as by utilizing cylinder pressure information processed through a combustion phasing determination algorithm resident on the electronic controller 23.

At query 46, the logic questions whether to transition from the current steady speed and load to a new speed and load. If the query returns a negative, the logic returns to query 36 to determine whether to adjust combustion phasing. If the answer to query 36 is yes, the logic advances to box 42 and adjusts the current EGR rate relative to the base EGR rate corresponding to the current steady speed and load. The logic may also include box 43 to change the fueling ratio of the low reactivity fuel to the high reactivity fuel to adjust combustion phasing. In addition, the logic may execute box 44 to adjust combustion phasing by adjusting a quantity distribution of the high reactivity fuel if box 34 determines that there are two or more injection sequences of the high reactivity fuel, such as per FIG. 3. In addition, the logic may execute box 45 to adjust a timing of at least one high reactivity fuel injection sequence in order to adjust combustion phasing.

After adjustment of one or more of these variables, the logic then returns back to box 37 to inject the low reactivity fuel in a subsequent engine cycle. The low reactivity fuel is again mixed with air and recirculated exhaust gas at box 38. At box 39, the high reactivity fuel is injected according to the previously defined injection sequences as possibly adjusted, and the charge mixture is compression ignited and burned at box 40. At box 41 the combustion phasing is again determined.

At query 46, the logic asks whether to transition from the current speed and load to a new speed and load. If this query returns a yes, the logic advances to box 47 to determine a new base EGR rate for the desired new speed and load. At box 48, a fueling ratio of low reactivity fuel to high reactivity fuel is determined. At box 49, the logic determines at least three injection sequences for the high reactivity fuel. At box 50, the logic determines a quantity and timing of each injection sequence of the at least three injection sequences, such as by using stored data in a look up table. At box 51, the air system attempts to adjust the current EGR rate toward the new base EGR rate of associated with the new speed and load, but as discussed previously, the time response of the EGR system may not be fast enough to effectively control combustion phasing during a transient. At query 52, the logic asks whether combustion phasing is in need of adjustment. If the query returns a negative, the logic advances to box 53 where the low reactivity fuel is injected. At box 54 the low reactivity fuel is mixed with air and recirculated exhaust gas. At box 55, the high reactivity fuel is injected according to the previously determined injection sequences. At box 56, the stratified reactivity charge mixture is compression ignited and burned. At box 57 the logic determines the combustion phasing of the combustion event.

At query 60, the logic asks whether the transition to the new speed and load is completed. If not, the logic loops back and continues the adjustment of the current EGR rates toward the new base EGR rate associated with the desired new speed and load at box 51. At query 52, the logic again asks whether combustion phasing should be adjusted. If the logic returns a yes, at least one of box 58 and 59 are executed. Box 58 seeks to adjust combustion phasing by adjusting a quantity distribution of the high reactivity fuel among the at least three injection sequences, whereas box 59 seeks to adjust combustion phasing by adjusting a timing of at least one injection sequence of the at least three injection sequences of the high reactivity fuel.

Although not shown, other variables may also be adjusted in order to adjust combustion phasing during the transient condition. For instance, the logic might also adjust a ratio of the low reactivity fuel to the high reactivity fuel as still another lever for controlling combustion phasing. After box 59, the logic returns to box 53 where the low reactivity fuel is injected. At box 54, the low reactivity fuel is mixed with air and recirculated exhaust gas. At box 55, the high reactivity fuel is injected according to the adjusted injection sequences, and the charge mixture is compression ignited and burned at box 56. At box 57, the logic again determines combustion phasing. At query 60, the logic again questions whether the transition to the new speed and load is completed. If not, the logic loops back to box 51. On the otherhand, if the transient is completed, the logic returns to box 32 to continue operating at the new steady speed and load as described previously.

### INDUSTRIAL APPLICABILITY

The present disclosure finds general applicability to any RCCI engine in need of a strategy for controlling combustion phasing during transient conditions when the engine is transitioning from a first speed and load to a second speed and load. The present disclosure finds specific applicability to RCCI engines in which the low reactivity fuel is port injected into the intake passage and the high reactivity fuel is directly injected into the engine cylinder. Finally, the present disclosure finds specific applicability to RCCI engines in which the low reactivity fuel is natural gas and the high reactivity fuel is distillate diesel fuel.

Referring again to FIGS. 1-5, a method of operating the RCCI engine 10 includes mixing the low reactivity fuel, air and recirculated exhaust gas in engine cylinder 11. The high reactivity fuel is injected directly into the engine cylinder 11 in at least one injection sequence during the compression stroke to produce a charge mixture with stratified reactivity. The at least one injection sequence could be one, two, three, or more injection sequences during a steady speed and load, but is at least three injection sequences during a transient condition. The charge mixture is ignited by compressing the charge mixture. The charge mixture is burned over a combustion duration at a combustion phasing.

At some point, the RCCI engine 10 transitions from a first speed and load to a second speed and load. The combustion phasing is controlled toward a desired combustion phasing through adjustment of a first set of variables when the engine is operating in a steady state condition associated with either the first speed and load or the second speed and load. The combustion phasing is controlled through adjustment of a second set of variables, which is different from the first set of variables when the engine is operating in a transient condition during a transition from the first speed and load to the second speed and load. The adjustment of the first set of variables includes adjustment of the EGR rate relative to a base EGR rate associated with either the first speed and load or the second speed and load. The adjustment of the second set of variables does not includes adjustment of the current EGR rate relative to the base EGR rate, but does include adjustment to at least one of a timing and a quantity of one injection sequence of the at least three injection sequences of the high reactivity fuel.

As discussed earlier, the at least three injection sequences are divided among a first timing window from 100° to 60° BTDC. A second timing window from 60° to 30° BTDC and a third timing window from 30° BTDC to 10° ATDC. Adjustment of the second set of variables, during a transient condition, may include retarding the combustion phasing by, at least in part, advancing a timing of the first injection sequence of the three injection sequences, or advancing the combustion phasing by, at least in part, retarding the timing of the first injection sequence. The adjustment of the second set of variables might include retarding the combustion phase by, at least in part advancing a timing of the second injection sequence of the at least three injection sequences during the transient condition, or advancing combustion phasing by, at least in part, retarding the timing of the second injection sequence. In addition, the adjustment of the second set of variables may include advancing the combustion phasing by, at least in part, advancing a timing of the third injection sequence, or retarding the combustion phasing by, at least in part, retarding a timing of the third injection sequence.

Combustion phasing during the transient condition can also be adjusted by redistributing the quantity of the high reactivity fuel among the at least three injection sequences. For instance, adjustment of the second set of variables may include retarding combustion phasing by, at least in part, increasing a quantity of the high reactivity fuel in the first injection sequence, or advancing combustion phasing by, at least in part, decreasing a quantity of high reactivity fuel in the first injection sequence. The adjustment of the second set of variables may also include retarding combustion phasing by, at least in part, decreasing a quantity of high reactivity fuel of the second injection sequence, or advancing combustion phasing by, at least in part increasing a quantity of high reactivity fuel in the second injection sequence. Finally, adjustment of the second set of variables might include retarding combustion phasing by, at least in part, decreasing a quantity of high reactivity fuel of the third injection sequence, or advancing combustion phasing by, at least in part, increasing the quantity of high reactivity fuel in the third injection sequence.

Both the first set of variables and the second set of variables may include adjustment to combustion phasing by changing a ratio of the low reactivity fuel to the high reactivity fuel. The adjustment of the first set of variables, which occurs during steady speed and load, may include changing a quantity distribution between a first injection sequence and a second injection sequence, such as when the engine is being operated according to the steady state injection strategy 80 shown in FIG. 3. Likewise, the first set of variables might include changing a timing of at least a first injection sequence and/or a second injection sequence when the steady state injection strategy 80 calls for two or more injection sequences of the high reactivity fuel as shown, for instance in FIG. 3, and possibly in FIG. 4.

The present disclosure insightfully recognizes that adjustment to combustion phasing can be achieved, at least in part, by adjusting a current EGR rate when operating in a steady speed and load, but recognizes that this control lever may not be available when operating in a transient condition transitioning from a first speed and load toward a second speed and load. The present disclosure also recognizes that lags in the air and EGR systems can render EGR rate control unavailable as a lever in controlling combustion phasing. The present disclosure solves this problem by teaching combustion phasing control during transient conditions by supplying a high reactivity fuel in at least three injection sequences, and adjusting combustion phasing by adjusting a quantity distribution and respective timings of each injection sequence of the at least three injection sequences.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A method of operating a reactivity controlled compression ignition engine, comprising the steps of:
mixing a low reactivity fuel, air, and recirculated exhaust gas in an engine cylinder;
injecting a high reactivity fuel directly into the engine cylinder in at least one injection sequence during a compression stroke to produce a charge mixture with stratified reactivity;
igniting the charge mixture by compressing the charge mixture;
burning the charge mixture over a combustion duration at a combustion phasing;
transitioning the engine from a first speed and load to a second speed and load;
controlling the combustion phasing toward a desired combustion phasing through adjustment of a first set of variables when the engine is operating in a steady state condition associated with either the first speed and load or the second speed and load; and
controlling the combustion phasing through adjustment of a second set of variables, which is different from the first set of variables, when the engine is operating in a transient condition during the transitioning step,
wherein the adjustment of the first set of variables includes adjustment of a current exhaust gas recirculation (EGR) rate relative to a base EGR rate associated with either the first speed and load or the second speed and load,
wherein the at least one injection sequence is at least three injection sequences during the transitioning step, and
wherein the adjustment of the second set of variables does not include adjustment of the current EGR rate relative to the base EGR rate, but does include adjustment of at least one of a timing and a quantity of one injection sequence of the at least three injection sequences of the high reactivity fuel.

2. The method of claim 1 wherein the at least three injection sequences during the transient condition includes a first injection sequence in a first timing window from 100 to 60 degrees before top dead center (BTDC), a second injection sequence in a second timing window from 60 to 30 degrees BTDC, and a third injection sequence in a third timing window from 30 degrees BTDC to 10 degrees after top dead center (ATDC).

3. The method of claim 2, wherein the adjustment of the second set of variables includes retarding the combustion phasing by, at least in part, advancing a timing of the first injection sequence, or
advancing the combustion phasing by, at least in part, retarding a timing of the first injection sequence.

4. The method of claim 2, wherein the adjustment of the second set of variables includes retarding the combustion phasing by, at least in part, advancing a timing of the second injection sequence, or
advancing the combustion phasing by, at least in part, retarding a timing of the second injection sequence.

5. The method of claim 2, wherein the adjustment of the second set of variables includes advancing the combustion phasing by, at least in part, advancing a timing of the third injection sequence, or
retarding the combustion phasing by, at least in part, retarding a timing of the third injection sequence.

6. The method of claim 2, wherein the adjustment of the second set of variables includes retarding combustion phasing by, at least in part, increasing a quantity of the high reactivity fuel of the first injection sequence, or
advancing combustion phasing by, at least in part, decreasing a quantity of the high reactivity fuel of the first injection sequence.

7. The method of claim 2 wherein the adjustment of the second set of variables includes retarding combustion phasing by, at least in part, decreasing a quantity of the high reactivity fuel of the second injection sequence, or
advancing combustion phasing by, at least in part, increasing a quantity of the high reactivity fuel of the second injection sequence.

8. The method of claim 2, wherein the adjustment of the second set of variables includes retarding combustion phasing by, at least in part, decreasing a quantity of the high reactivity fuel of the third injection sequence, or
advancing combustion phasing by, at least in part, increasing a quantity of the high reactivity fuel of the third injection sequence.

9. The method of claim 1, wherein the adjustment of the first set of variables further includes changing a ratio of the low reactivity fuel to the high reactivity fuel.

10. The method of claim 1, wherein the at least one injection sequence includes a first injection sequence and a second injection sequence, and the adjustment of the first set of variables further includes changing a quantity distribution of the high reactivity fuel between the first injection sequence and the second injection sequence.

11. The method of claim 1, wherein the at least one injection sequence includes a first injection sequence and a second injection sequence, the adjustment of the first set of variables further includes changing a timing of at least one of the first injection sequence and the second injection sequence.

12. The method of claim 1, wherein the transitioning step includes changing from a first base EGR rate that corresponds to the first speed and load toward a second base EGR rate that corresponds to the second speed and load.

13. The method of claim 1, wherein the low reactivity fuel is port injected outside the engine cylinder.

14. The method of claim 1, wherein the high reactivity fuel includes distillate diesel fuel, and the low reactivity fuel includes natural gas.

15. A reactivity controlled compression ignition engine comprising:
an engine housing that defines at least one engine cylinder, an intake passage and an exhaust passage;
a source of low reactivity fuel;
a source of high reactivity fuel;
at least one fuel injector attached to the engine housing, and positioned to respectively supply fuel from the source of low reactivity fuel and the source of high reactivity fuel to the engine cylinder;
a piston positioned to reciprocate in the engine cylinder between a top dead center and a bottom dead center;
the exhaust passage being fluidly connected to the intake passage through an exhaust gas recirculation (EGR) control valve;
an electronic controller in control communication with the EGR control valve and the at least one fuel injector; and
means, including the electronic controller, for determining a combustion phasing of a compression ignited charge mixture having stratified reactivity, the charge mixture including recirculated exhaust gas, air, low reactivity fuel, and high reactivity fuel,
the electronic controller includes a combustion phasing control algorithm configured to control the combustion phasing toward a desired combustion phasing through adjustment of a first set of variables when the engine is operating in a steady state condition associated with a steady speed and load, and control the combustion phasing through adjustment of a second set of variables, which is different from the first set of variables, when the engine is operating in a transient condition transitioning from a first speed and load toward a second speed and load,
wherein the adjustment of the first set of variables includes adjustment of a current EGR rate relative to a base EGR rate associated with either the first speed and load or the second speed and load, and
wherein the adjustment of the second set of variables does not include adjustment of the current EGR rate relative to the base EGR rate, but does include adjustment of at least one of a timing and a quantity of one injection sequence of at least three injection sequences of the high reactivity fuel.

16. The engine of claim 15, wherein the at least three injection sequences during the transient condition includes a first injection sequence in a first timing window from 100 to 60 degrees before top dead center (BTDC), a second injection sequence in a second timing window from 60 to 30 degrees BTDC, and a third injection sequence in a third timing window from 30 degrees BTDC to 10 degrees after top dead center (ATDC).

17. The engine of claim 16, wherein the combustion phasing control algorithm is configured to change a timing of at least one injection sequence of the at least three injection sequences to advance or retard combustion phasing during the transient condition.

18. The engine of claim 16, wherein the combustion phasing control algorithm is configured to change a quantity distribution among the at least three injection sequences to advance or retard combustion phasing during the transient condition.

19. The engine of claim 15, wherein the electronic controller is configured to change the current EGR rate from a first EGR base rate associated with the first speed and load toward a second base EGR rate associated with the second speed and load during the transient condition.

20. The engine of claim 15, wherein the source of low reactivity fuel includes a natural gas common rail, and
the source of high reactivity fuel includes a diesel fuel common rail.
